(19) United States
(12) Patent Application Publication
(10) Pub. No.: US 2010/0154666 A1
(43) Pub. Date: Jun. 24, 2010

(54) QUICK CONNECT-DISCONNECT PROTECTION RING FOR PRINTING SLEEVES

(75) Inventor: FELICE ROSSINI, Milano (IT)

Correspondence Address: DORITY & MANNING, P.A., POST OFFICE BOX 1449, GREENVILLE, SC, 29602-1449, US

(73) Assignee: ERMINIO ROSSINI S.p.A., Milano (IT)

(21) Appl. No.: 12/645,651

(22) Filed: Dec. 23, 2009

(30) Foreign Application Priority Data
Dec. 23, 2008 (IT) MI2008A002300

(51) Int. Cl. B41F 27/06

(52) U.S. Cl. 101/378

(57) ABSTRACT

A protection ring for a printing sleeve such as a sleeve or cylinder carrying the characters to be printed, or an adapter sleeve for supporting said sleeve or cylinder, the sleeve to be mounted on a rotary mandrel provided with a register pin, can include an annular body to be disposed on an end edge of the sleeve. The body defines a first coupling member for its detachable coupling to the sleeve, which is provided with a second coupling member for cooperating with the first coupling member. The body includes a register notch for cooperating with the mandrel's register pin. The body includes a first orientation element for properly orienting the ring on the sleeve, to enable the ring to be disposed on the sleeve such that the register notch lies in a position suitable for cooperation with the register pin.

### CROSS-REFERENCE TO RELATED APPLICATIONS

The present application hereby claims priority to currently pending Italian Application Serial Number MI2008A002300, filed Dec. 23, 2008.

### STATEMENT REGARDING FEDERALLY SPONSORED RESEARCH OR DEVELOPMENT

N/A

### BACKGROUND OF THE INVENTION

The present invention relates to a protection ring for a printing sleeve that is configured to be mounted on a rotary mandrel that is provided with a register pin.

In flexographic printing, the sleeves (as used herein, this term “sleeve” meaning either “adapter” sleeves for mounting printing sleeves or printing sleeves carrying the data to be printed) are known to be mounted on a rotary support cylinder or mandrel of a printing machine. Mounting the sleeve on the mandrel can be achieved by known methods. For example, compressed air can be supplied onto the surface of mandrel to create an air cushion along which the sleeve slides onto the mandrel.

To enable the sleeve to be correctly mounted on the mandrel requires a repeatable alignment of the sleeve and the mandrel. Accordingly, a projecting register pin of predetermined diameter (usually 6 mm) typically is disposed at one end of this mandrel of the printing machine. This rigid metal pin projects radially from the free surface of the mandrel on which the sleeve is to be mounted. Likewise, the sleeve comprises at one end a locating notch (aka register notch), which receives the register pin of the mandrel when the sleeve has been completely mounted on the mandrel. This engagement of the pin in the locating notch enables the sleeve to be correctly mounted on the mandrel by ensuring coupling uniformity between these elements. Examples of this type of arrangement can be seen at U.S. Pat. Nos. 5,904,095 to Nelson and 6,467,409 to Busshoff, which are hereby incorporated herein for all purposes by this reference.

In some sleeves, the locating notch is defined in a solid annular member that is permanently fixed to one end of the sleeve, and this annular member is composed of metal such as aluminium, steel or brass or a rigid hard plastic material of about 90 Shore D hardness.

It has been found that during mounting, the sleeve's free edge bearing the locating notch by which the sleeve is mounted onto the mandrel, can collide against the pin. As the register pins of the rotary mandrels or support cylinders are composed of metal, usually steel, whereas the sleeves are composed of composite materials, even a single such collision can damage the free edge of the sleeve containing the register recess. Such damage is likely to occur in particular in proximity to the locating notch, hence compromising the ability to ensure the requisite repeatable alignment of the sleeve and the mandrel. Moreover, the damage to the edge of the sleeve eventually adversely affects the Total Indicated Runout (T.I.R.) of the sleeve and renders the sleeve unusable for further printing jobs.

It likewise has been found that during mounting, the annular member that bears the locating notch and that is permanently fixed to the sleeve's free edge also can collide against the pin. Sometimes such collisions result in the severing of the register pin or sever damage to same thereby rendering the mandrel useless or at least in need of repair. Moreover, even less violent collisions between the register pin and the annular member bearing the locating notch can result in burrs being formed in the annular member, and such burrs can mar the outer surface of the mandrel and render the mandrel useless or at least in need of repair. Additionally, the collisions between the annular member and the register pin eventually damage the edge of the annular member sufficiently so as to render the sleeve useless, either from adversely affecting the Total Indicated Runout (T.I.R.) of the sleeve and/or damaging the locating notch so that it no longer performs the desired locating function, and in each case thereby renders the sleeve unusable for further printing jobs.

### OBJECTS OF THE INVENTION

A principal object of the present invention is to provide a way to ensure that the sleeve's free edge containing the locating notch can be simply and reliably protected from collisions against the register pin of the mandrel of a printing machine.

Another principal object of the present invention is to provide a way to ensure that the register pin of the mandrel of a printing machine can be simply and reliably protected from collisions against the sleeve's free edge containing the locating notch.

A further principal object of the present invention is to provide a replaceable protection ring able to be associated in a simple and reliable manner with the free edge of the sleeve containing the locating notch for the purpose of protecting it from collisions against the register pin.

An additional principal object of the present invention is to provide a replaceable protection ring able to be associated in a simple and reliable manner with the free edge of the sleeve containing the locating notch for the purpose of protecting the register pin from damage resulting from collisions against the locating notch.

A particular object of the invention is to provide a ring of the stated type which can be uniquely coupled to the sleeve to enable reliable and correct mounting of this sleeve onto the rotary mandrel or support cylinder.

Another object is to provide a ring of the stated type for instant connection to the sleeve and detachment from the sleeve without damaging the sleeve, the ring hence being connectable to this sleeve without the use of permanent mechanical fixing members or glue.

Still another object is to provide a ring of the stated type that easily and inexpensively can be replaced if damaged without damaging the sleeve during the replacement process.

A yet further object is to provide a sleeve having a ring of the stated type on each opposite end of the sleeve for instant connection to the sleeve without the use of permanent mechanical fixing members or glue.

Additional objects and advantages of the invention will be set forth in part in the description that follows, and in part will be obvious from the description, or may be learned by practice of the invention. One or more of the objects and advantages of the invention may be realized and attained by means of the instrumentalities and combinations particularly pointed out in the description below and in the appended claims.

The accompanying drawings, which are incorporated in and constitute a part of this specification, illustrate at least one presently preferred embodiment of the invention as well as some alternative embodiments. These drawings, together with the description, serve to explain the principles of the invention but by no means are intended to be exhaustive of all of the possible manifestations of the invention.

### BRIEF DESCRIPTION OF THE DRAWINGS

The present invention will be better understood from the accompanying drawings, which are provided by way of non-limiting example and in which:

FIG. 1 is a perspective view of a protection ring of the invention associated with the partial end of a printing sleeve, the end of the latter being partially shown;

FIG. 1A is a perspective view of a protection ring of the invention associated with an adapter sleeve on which a printing sleeve is mounted;

FIG. 1B is a view taken in cross-section of an adapter sleeve on which a sleeve or printing cylinder is mounted and before the protection ring is attached;

FIG. 1C is a view taken in cross-section of an adapter sleeve on which a sleeve or printing cylinder is mounted and with an embodiment of a protection ring attached;

FIG. 1D is an enlarged view of FIG. 1C;

FIG. 2 is a front view of the ring of FIG. 1;

FIG. 3 is a section on the line 3-3 through the ring shown in FIG. 2;

FIG. 4 is an enlarged view of the part indicated by A in FIG. 3;

FIG. 5A is an enlarged view of the part indicated by B in FIG. 2;

FIG. 5B is an enlarged view of an alternative embodiment of the part indicated by B in FIG. 2;

FIG. 6 is a partial cross-sectional view taken of an adapter sleeve mounted on a mandrel of a printing machine and with an embodiment of a protection ring attached to the sleeve; and

FIG. 6A is an enlarged perspective view of the region on the mandrel in FIG. 6 indicated by A.

### DETAILED DESCRIPTION OF EXEMPLARY PREFERRED EMBODIMENTS

Reference now will be made in detail to presently preferred exemplary embodiments of the invention, more than one example of which being illustrated in the accompanying drawings. Each example is provided by way of explanation of the invention, which is not restricted to the specifics of the examples. In fact, it will be apparent to those skilled in the art that various modifications and variations can be made in the present invention without departing from the scope or spirit of the invention. For instance, features illustrated or described as part of one embodiment, can be used on another embodiment to yield a still further embodiment. Thus, it is intended that the present invention cover such modifications and variations as come within the scope of the appended claims and their equivalents. The same numerals are assigned to the same components throughout the drawings and description.

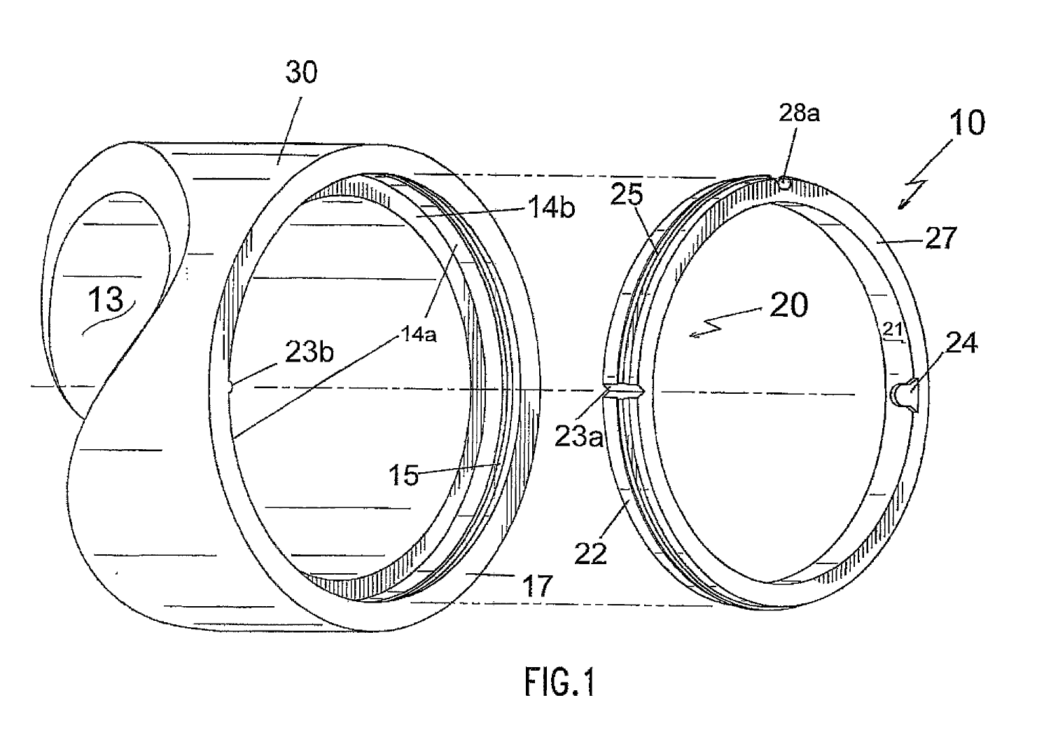

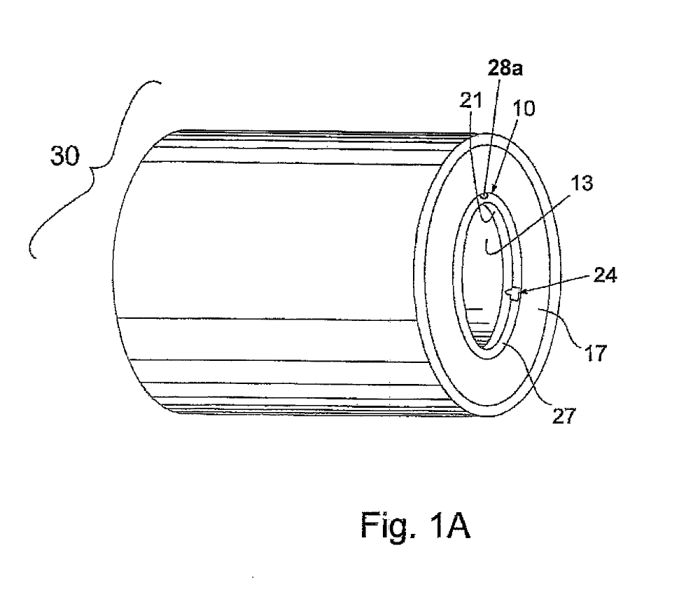

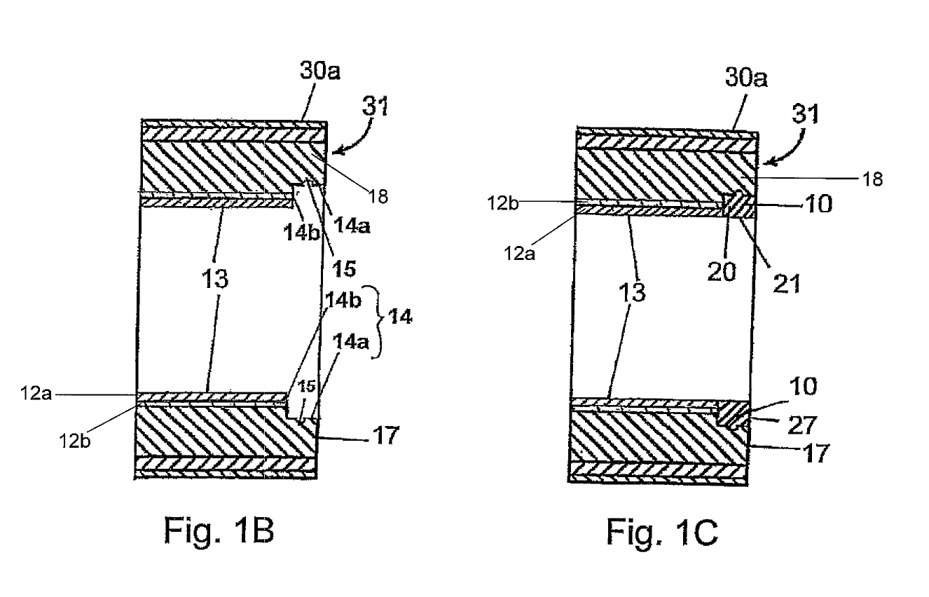

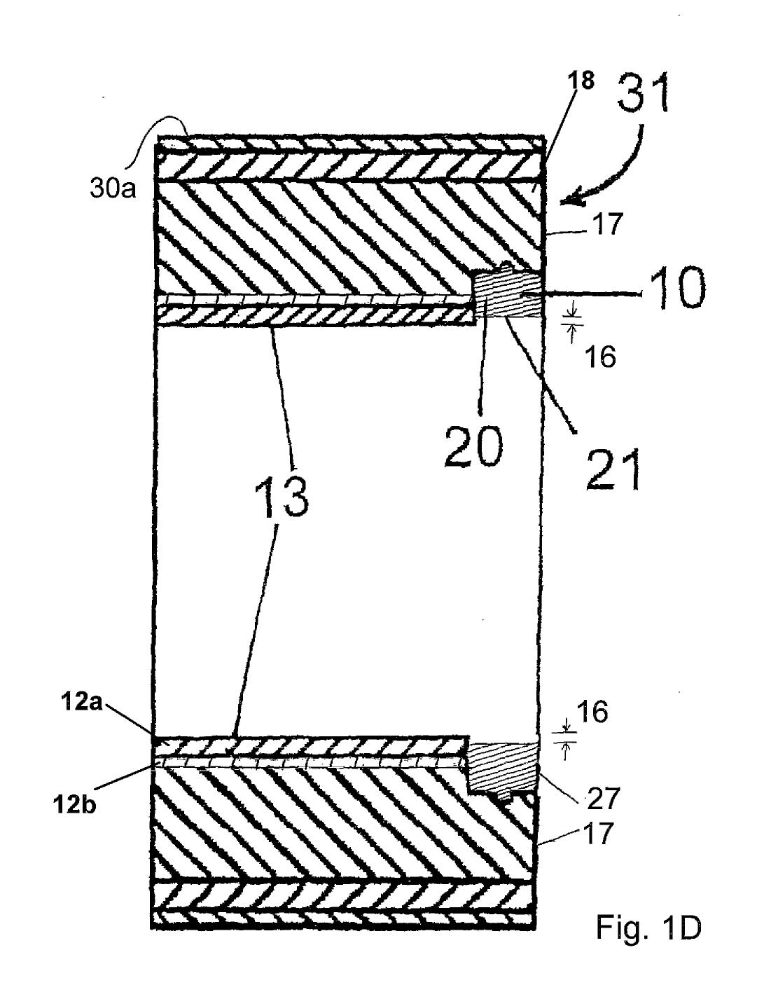

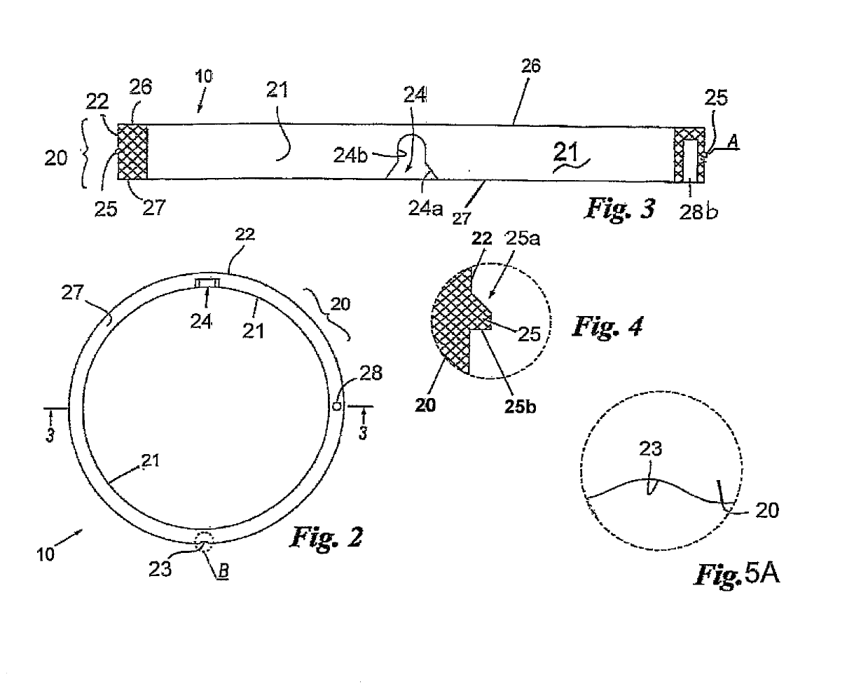

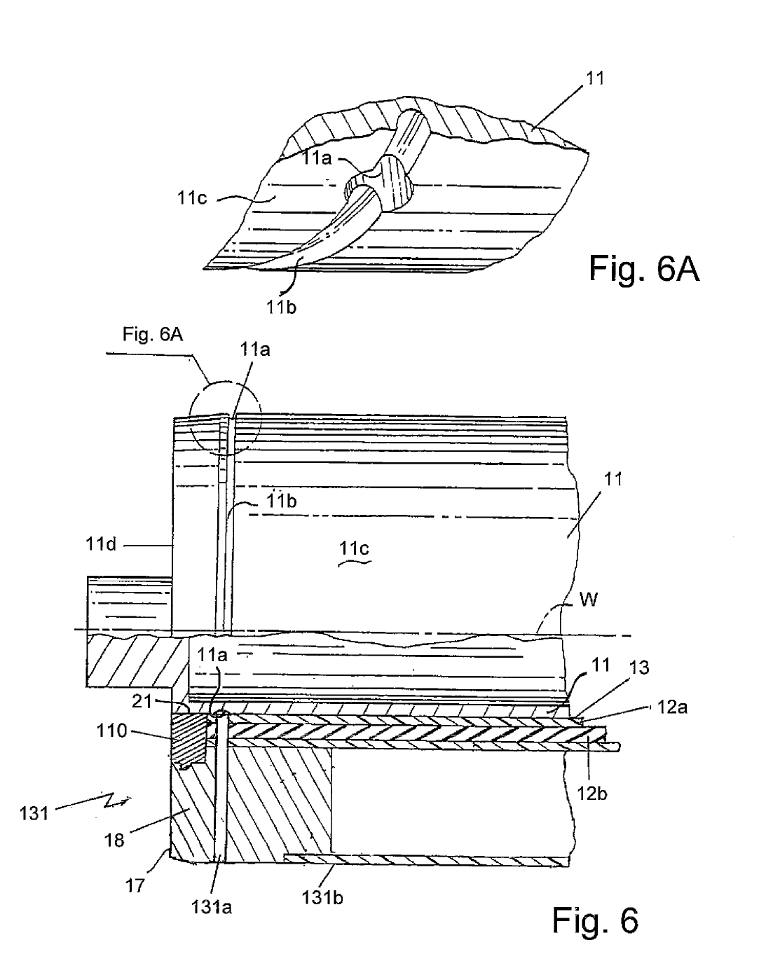

As shown in FIG. 1, an exemplary protection ring according to the invention is indicated overall by the designating numeral 10 and comprises an annular body 20 (e.g., FIG. 2) that is to be mechanically connected to a cylindrical sleeve 30, which in the example of FIG. 1 is a printing sleeve. As shown in the examples of FIGS. 1B, 1C and 1D, this sleeve also can be an adapter sleeve 31 supporting a printing cylinder 30a fitted to this adapter sleeve 31 in any known manner (for example by compressed air coupling, the details of which being omitted from the drawing in order to simplify the explanation of the workings of the protection ring). FIG. 6 for example shows another embodiment of a so-called flow-through adapter sleeve 131 mounted on the mandrel 11 of a printing machine (not shown). Each of these sleeves (30, 31 or 131 as the case may be) defines an innermost cylindrical surface 13, which is the sleeve's surface that is to be mounted at a required orientation on a rotary mandrel 11 (not shown in FIGS. 1A, 1B, 1C and 1D) of a printing machine (not shown). An example of a mandrel of this type can be seen in FIG. 3 of U.S. Pat. No. 5,904,095 to Nelson. However, if an adapter sleeve were to be fitted with a register pin, such pin-fitted adapter sleeve itself could be considered a mandrel for the sleeve that is mounted on such pin-fitted adapter sleeve, and the protection ring of the present invention would become suitable for attachment to such mounted sleeve (or to a second adapter sleeve).

To avoid redundancy, FIGS. 1, 1A, 1B, 1C, 1D and 6 show only one of the opposite ends of the respective sleeve 30, 31, 131. However, the sleeves contemplated in accordance with the present invention desirably can have both opposite ends configured as described herein to receive one of the protection ring embodiments of the present invention. As shown in FIGS. 1, 1A, 1B, 1C, 1D and 6, one end of the sleeve 30, 31, 131 defines a free outermost end edge 17. As shown in FIGS. 1 and 1B for example, this one end of the sleeve also defines therein a seat 14 that is axially recessed inwardly from the outermost end edge 17 of the sleeve 30, 31. As shown in FIGS. 1 and 1B, the seat 14 desirably is formed by a circumferential shoulder surface 14a and an end flange surface 14b that is connected to the circumferential shoulder surface 14a. As shown in FIGS. 1 and 1B, the sleeve's circumferential shoulder surface 14a defines an inside cylindrical surface, which desirably can be parallel to the sleeve's innermost cylindrical surface 13 but having a larger diameter than the sleeve's innermost cylindrical surface 13.

FIG. 6 for example shows the trailing end of a flow-through adapter sleeve 131 with an air flow hole 131a defined radially through the sleeve 131 and configured and disposed to align with the air holes 11a and the associated circumferential air groove 11b in the outer surface 11c of the mandrel 11, which is rotatable about the central axis W. As shown in FIG. 6, any of the sleeves 30, 31, 131 to be fitted with an embodiment of a protection ring 10, 110 desirably is configured on each opposite end with a flange member 18 in which is formed the seat 14 (see FIGS. 1 and 1B for example) that is configured for receiving a protection ring embodiment 10, 110 and which defines the free outermost end edge 17 of the sleeve 10, 110. The body 20 of each sleeve 30, 31, 131 includes each flange member 18 together with whatever cylindrical layers are present between the innermost cylindrical surface 13 and the outer surface of the sleeve 30, 31, 131. Each flange member 18 desirably is formed from rigid urethane of about 80 shore D hardness, or carbon fiber or fibreglass reinforced resin or metal, each of which material providing a flange member 18 of sufficient rigidity to provide acceptable concentricity and durability when the sleeve is in use and yet capable of being machined with the configuration needed for the seat 14.

The seat 14 is configured to receive and non-rotatably retain therein, the protection ring 10, 110. It is contemplated that a newly manufactured protectively equipped sleeve can be so configured to receive a protection ring 10, 110. It also is contemplated that a sleeve already in use can be retrofitted to become a protectively equipped sleeve by so machining a seat 14 into the outermost end edge 17 of the sleeve to receive a protection ring 10, 110. In this way, some sleeves that may have been rendered useless due to damage caused by collision with a register pin, can be repaired and returned to useful service.

As shown in FIGS. 1, 1A, 1C, 1D and 6, the protection ring 10, 110 is inserted into the seat 14 that is provided in the free lateral end edge 17 of the sleeve 30, 31, 131 to be mounted on a rotary mandrel 11 (not shown in FIG. 1, 1A, 1B, 1C, or 1D) of a printing machine (not shown). The protection ring 10, 110 is configured to cooperate with a conventional register pin (not shown) of the mandrel 11 (not shown in FIG. 1, 1A, 1B, 1C or 1D).

As shown in FIG. 2 for example, the protection ring 10 includes an annular body 20 defining an axis of rotation, which is normal to the plane of FIG. 2. The annular body 20, which cooperates with the register pin, is made of rigid/elastic material, for example (but non-limitingly) of polyurethane, with hardness characteristics (by way of non-limiting example) of between about 40 and about 50 Shore D, and desirably about 45 Shore D. This rigidity/elasticity characteristic makes the protection ring 10, 110 less vulnerable and more resilient to collisions against the register pin. By providing a soft cushion for engaging the register pin, this rigidity/elasticity characteristic of the protection ring 10, 110 also ensures that any collisions between the ring 10, 110 and the register pin on the mandrel will not damage the register pin. Additionally, this rigidity/elasticity characteristic of the protection ring 10, 110 also ensures that the surface of the mandrel will not be marred by scratches from burrs that form on the permanent rings made of metal or hard plastic. Moreover, this rigidity/elasticity characteristic renders the protection ring 10, 110 sufficiently flexible to be able to deform when being installed into the seat 14 and when being detached from the seat 14 of the sleeve 30, 31, 131. However, if the protection ring 10 were to become damaged, the protection ring 10 can be replaced with another undamaged protection ring 10 without this substitution of a new protection ring 10 affecting the efficiency of the sleeve's operation on the printing machine.

The annular body 20 desirably can be made by pouring suitable liquid polyurethane precursor into a suitably shaped mold, curing the liquid in the mold to form a solid precursor and machining the solid precursor to create the desired features (discussed herein) to form the finished protection ring 10.

As shown in FIG. 1 for example, the protection ring 10 defines an inner circumferential surface 21 and an outer circumferential surface 22 disposed concentrically with respect to the inner circumferential surface 21. As shown in FIG. 1, the outer circumferential surface 22 of the annular body 20 is configured to complement and cooperate with the circumferential shoulder surface 14a of the seat 14 that is defined recessed from the free outermost end edge 17 of the sleeve 30, 31. As shown in FIG. 3, the annular body 20 further defines a first axial end 26 and a second axial end 27 disposed opposite the first axial end 26. The first axial end 26 is configured to be disposed facing the seat 14 of the sleeve 30, 31. Desirably, the first axial end 26 is configured to be disposed against the end flange surface 14b of the seat 14 of the sleeve 30, 31 as shown in FIG. 1B. The axial thickness of the protection ring measured between the first axial end 26 and the second axial end 27 desirably is on the order of about ten millimetres. The radial thickness of the protection ring measured between the inner circumferential surface 21 and the outer circumferential surface 22 of the annular body 20 desirably is on the order of about five millimetres and more desirably about seven millimetres.

The inner circumferential surface 21 of the annular body 20 is configured to complement and cooperate with the usual cylindrical outer surface of the rotary mandrel. As shown in FIGS. 1D and 6, the inner circumferential surface 21 of the protection ring 10, 110 is configured parallel to and concentric with the innermost cylindrical surface 13 of the sleeve 31, 131.

As shown in FIGS. 2 and 3, a register notch 24 is defined into the second axial end 27 of the annular body 20. The register notch 24 is defined through the inner circumferential surface 21 of the annular body 20 and configured for receiving and engaging the mandrel's register pin (not shown) and cooperate with the aforesaid register pin to properly orient the sleeve on the mandrel (not shown). As shown in FIG. 3, this register notch 24 desirably is defined by an initial open ended flared portion 24a that increases the target area for receiving the register pin and gradually narrows toward a closed end portion 24b that is configured for holding the register pin on the end of the mandrel (not shown) of the printing machine (not shown). The register notch 24 alternatively can be designed with a different shape. One such alternative shape is a bayonet shape that is known in the art and depicted in FIG. 4A of U.S. Pat. No. 6,360,662 to Busshoff, which is hereby incorporated herein for all purposes by this reference.

To ensure the required orientation of the sleeve 30, 31, 131 on the rotary mandrel 11 (not shown in FIGS. 1, 1A, 1B, 1C and 1D), it is necessary to ensure that the annular body 20 becomes oriented on the sleeve 30, 31 such that the register notch 24 lies in a suitable position for cooperation with the mandrel's register pin. Accordingly, the protection ring desirably includes a first element of an orientation feature. The first element of the orientation feature desirably is defined in the outer circumferential surface 22 of the annular body 20. The first element of the orientation feature desirably is configured to engage with the orientation feature's complementarily shaped second element, which desirably is defined in the circumferential shoulder surface 14a of the seat 14 formed in the end flange surface of the sleeve 30, 31.

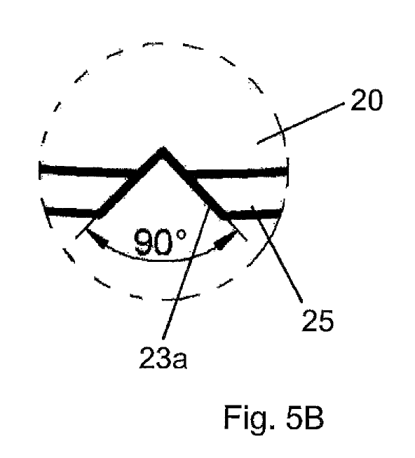

As shown in FIG. 2 for example, a first orientation element 23 is preferably and advantageously provided in the outer circumferential surface 22 of the annular body 20 for properly orienting the protection ring 10 on the sleeve 30 or 31. Moreover, the first orientation element 23 also is configured to prevent relative circumferential movement, i.e., rotational movement, between the sleeve 30, 31 and the protection ring 10, 110. As shown in FIG. 5A for example, this first orientation element desirably can be defined by an indentation or recess 23 that is configured and disposed to receive a correspondingly and complementarily shaped projection (not shown) provided to extend radially outwardly from the circumferential shoulder surface 14a of the seat 14 in the end flange surface of the sleeve 30, 31 so that the two orientation elements engage one another in a manner that prevents rotation of the ring 10, 110 with respect to the sleeve 30, 31. Alternatively, the first element of the orientation feature desirably can include a projection (not shown) extending radially outwardly from the outer circumferential surface 22 of the annular body 20. Such a projection desirably is arranged to cooperate with a correspondingly shaped recess (not shown) provided in the circumferential shoulder surface 14a of the end flange of the sleeve 30 or 31 in a manner to prevent rotation of the ring 10, 110 with respect to the sleeve 30, 31.

Each of the recess 23 and the complementarily shaped projection can have an arcuate symmetry such as shown in FIG. 5A. Shapes with an arcuate symmetry include a sphere, an ovoid, an ellipsoid, a paraboloid and some combination of one or more of these surface shapes. By virtue of the engagement between the indentation/recess 23 and the sleeve's correspondingly shaped projection, the protection ring 10, 110 can be disposed on the sleeve 30, 31 or 131 in a unique and guided manner such that the register notch 24 becomes disposed reliably in the correct position for cooperating correctly with the register pin (not shown) of the rotary mandrel 11 (not shown in FIGS. 1, 1A, 1B, 1C, 1D). As shown in FIG. 2 for example, the first orientation element 23 desirably is located in a position that is diametrically opposite the register notch 24.

Other correspondingly shaped embodiments of orientation elements can be provided as the orientation feature. For example, as shown in FIG. 5B, an embodiment of the first orientation element desirably can include a cutout 23a that is defined axially and radially through the outer circumferential surface 22 of the annular body 20. As shown in FIG. 1 for example, the cutout 23a desirably is configured to receive therein a complementarily shaped projection 23b extending radially outwardly from the circumferential shoulder surface 14a of the end flange of the sleeve 30 or 31. As shown in FIG. 5B, the cutout 23a desirably can be a V-shaped cutout that is configured to receive therein a correspondingly V-shaped projection of the sleeve 30, 31 or 131.

To achieve rapid reliable connection of the protection ring 10, 110 to the sleeve 30, 31, 131, a coupling is provided to detachably connect the protection ring 10, 110 to the sleeve 30, 31, 131. The coupling is configured to prevent relative axial movement between the sleeve 30, 31, 131 and the protection ring 10, 110. A first member of the coupling is defined about the outer circumferential surface 22 of the annular body 20 and configured with a shape complementary with the shape of a second member of the coupling defined in the seat 14 of the sleeve 30, 31, 131. In this way, the first member of the coupling desirably is configured so as to engage with the coupling's complementarily shaped second member and detachably lock the annular body 20 in the seat 14 of the sleeve 30, 31, 131 against axial movement between the sleeve 30, 31 and the annular body 20. As shown in FIG. 1D for example, with the protection ring 10 so locked in the seat 14 of the sleeve 30 or 31, the inner circumferential surface 21 of the annular body 20 of the ring 10 lies parallel to the innermost cylindrical surface 13 of the sleeve 30, 31, and the second axial end 27 of the annular body 20 lies coplanar with the outermost end edge 17 of the sleeve 30, 31.

As shown in FIGS. 3 and 4 for example, a first member of the coupling desirably includes a rib 25 or ridge 25 extending in the circumferential direction and configured to detachably engage and nest securely within a complementary groove 15 (FIGS. 1 and 1B) defined circumferentially in the circumferential shoulder surface 14a of the seat 14 of the sleeve 30, 31. The rib 25 is configured in size and shape to conform to the corresponding groove 15 defined in the sleeve 30, 31. For example, the geometric cross-sectional outline of the rib 25 can be of rectangular, trapezoidal or other cross-section of such a size as to conform to the groove 15. When so configured, the coupling can achieve rapid connection without slack between the rib 25 and the sleeve's corresponding groove 15 when the protection ring 10 is detachably installed into the seat 14 in the end of the sleeve 30, 31.

As shown in FIGS. 3 and 4 for example, the rib 25 forming the first member of the coupling desirably can be defined in part by a chamfered surface 25a facing toward the first axial end 26 of the annular body 20. As shown in FIG. 4 for example, this chamfered surface 25a forms an obtuse angle with the outer circumferential surface 22 of the annular body 20 of the protection ring 10 and thereby facilitates entry of the rib 25 into the groove 15 in the sleeve 30, 31. As shown in FIG. 4 for example, the back surface 25b of the rib 25 faces opposite the chamfered surface 25a and faces the second axial end 27 of annular body 20. This back surface 25b desirably forms a right angle with the outer circumferential surface 22 of the annular body 20 of the protection ring 10 and thereby blocks axial movement of the rib 25 out of the groove 15 in the sleeve 30, 31. By way of non-limiting example, the rib 25 desirably can have an overall cross-section of about one millimeter (1 mm) and desirably project about 0.5 to about 0.7 mm from the smooth cylindrical portion of the outer circumferential surface 22 of the annular body 20 of the sleeve 30, 31.

The rib 25 desirably projects radially from the outer circumferential surface 22 of the annular body 20 of the protection ring 10 and desirably can be continuous around the entire outer circumferential surface 22 of the annular body 20. In an alternative embodiment, the first member of the coupling desirably will include at least one radial projection or tooth 25 that is provided and arranged to cooperate with a corresponding slot 15 (FIG. 1B) provided in the sleeve 31, and each of the tooth 25 and slot 15, while extending in the circumferential direction, does not extend continuously around the entire circumference of the respective body 20 and sleeve 30, 31. In yet another embodiment, the slot 15 is continuous but one or more teeth 25 is/are discontinuous in its/their circumferential extent. Other complementary configurations for the two coupling members also can be provided.

Moreover, alternatively, the first member of the coupling can be at least one groove extending radially into the outer circumferential surface 22 of the annular body 20 of the ring 10. In such an embodiment (not shown), the groove is configured to detachably engage and receive securely therein a complementarily shaped projection that extends radially outwardly from the circumferential shoulder surface 14a that partially defines the seat 14 of the sleeve 30, 31 such that the inner circumferential surface 21 of the annular body 20 of the ring 10 lies parallel to the innermost cylindrical surface 13 of the sleeve 30, 31 and the second axial end 27 of the annular body 20 lies coplanar with the outermost end edge 17 of the sleeve 30, 31.

As noted above, a coupling fixes the protection ring 10, 110 against axial movement relative to the sleeve 30, 31 or 131. Notwithstanding this coupling, if the protection ring 10, 110 that is installed in the seat 14 of a sleeve 30, 31 or 131 becomes damaged, then the damaged protection ring 10, 110 must be detached and removed from the sleeve and replaced with a new protection ring 10, 110. The protection ring 10, 110 can be separated and removed from the sleeve 30, 31, 131 in various ways. One of these is by the provision of a removal seat that is defined into the second axial end 27 of the annular body 20. The removal seat desirably is configured to cooperate with a tool for applying leverage for detaching the protection ring from the seat 14 of the sleeve 30, 31 or 131.

As shown in FIGS. 1 and 1A for example, the removal seat desirably is configured in the shape of a half-moon cylindrical cutout 28a that can be formed into the outer circumferential surface 22 of the annular body 20 of the protection ring 10. As shown in FIG. 1A, the half-moon cutout 28a will extend through the annular body 20 from the first axial end 26 but will not be cut through to the second axial end 27. In this way, the pry tool will not be able to engage the end flange surface 14b and cause damage to same. In a less desirable alternative embodiment shown in FIG. 1, the half-moon cutout 28a will extend axially completely through the annular body 20 from the first axial end 26 to the second axial end 27. Desirably, the half-moon cutout 28a will be positioned on the annular body 20 midway between where the register notch 24 and the orientation feature (e.g., 23) of the protection ring 10, 110 will reside. The operator can insert a pry tool, such as a flat head screwdriver, into the half moon cutout 28a in the outer circumferential surface 22 of the annular body 20 of the ring 10, 110 and squeeze the ring inwardly toward the central axis of the ring 10, 110 and pull the ring 10, 110 away from circumferential shoulder surface 14a of the seat 14 to pop the ring 10, 110 out of the seat 14 of the sleeve 30 or 31 without damaging the sleeve.

In the embodiment shown in FIG. 3, the removal seat desirably includes an elongated hole 28b that desirably extends axially into the annular body 20 through the second axial end 27 of the annular body 20. The opening to the hole 28b desirably is configured to lie coplanar with the free outermost end edge 17 of the sleeve 30 or 31. This hole 28b is configured to receive a correspondingly configured tool (not shown), which when inserted into the hole 28b, enables the protection ring 10, 110 to be pried out of the seat 14 in the sleeve 30, 31 or 131. Desirably, the hole 28b is formed dead-ended and advantageously is internally threaded to engage a tool that has a threaded exterior surface that can be screwed into the hole 28b.

In accordance with one aspect of the present invention, a protectively equipped sleeve has at least one of its opposite ends configured with a seat 14 to receive therein a protection ring. However, it is desired that each of the opposite ends of the protectively equipped sleeve is configured with a seat 14 to receive its own protection ring so that the sleeve can be mounted onto the mandrel from either end of the sleeve. The end of the sleeve 30, 31, 131 shown in FIGS. 1 and 1D for example is the leading end of the sleeve that is first to be slid onto the mandrel from the end of the mandrel where the air mounting holes are provided and then slid all the way to the opposite end of the mandrel where the register pin is to be engaged by the register notch in the protection ring 10. FIG. 6 shows the trailing end of the sleeve 131 that eventually is position nearer where the air mounting holes 11a are provided on the mandrel 11. Because of the presence of these air mounting holes 11a in the mandrel 11, the configuration of a protection ring embodiment 110 intended for the trailing end of the sleeve 131 shown in FIG. 6 desirably differs slightly from the protection ring embodiment 10 intended for the leading end of the sleeve 31 shown in FIG. 1D.

In the protection ring embodiment 10 intended for the leading end of the sleeve (e.g., 31 shown in FIG. 1D), the diameter of the inner circumferential surface 21 of the protection ring 10 is configured slightly larger than the diameter of the innermost cylindrical surface 13 of the sleeve 30, 31 by about ten one-thousandths of an inch (0.010″). The resulting radial gap 16, which in FIG. 1D is shown in an exaggerated size relative to the diameter of the sleeve's innermost cylindrical surface 13, must provide sufficient clearance to allow the inner circumferential surface 21 of the protection ring 10 to slide over the end of the mandrel (or adapter sleeve, as the case may be) without blocking the air mounting holes in the mandrel (or adapter sleeve) that permit expansion of the innermost cylindrical surface 13 of the sleeve 30, 31 needed to air mount the sleeve 30, 31.

However, in the protection ring embodiment 110 intended for the trailing end of the sleeve (e.g., 131 shown in FIG. 6), the diameter of the inner circumferential surface 21 of the protection ring 10 is configured to be the same as the diameter of the innermost cylindrical surface 13 of the sleeve 30, 31, 131. Thus, there is no radial gap 16 in the protection ring embodiment 110 intended for the trailing end of the sleeve (e.g., 131 shown in FIG. 6).

As shown in FIGS. 6 and 6A for a trailing end protection ring 110, the axial thickness of the protection ring 110 is on the order of about ten millimetres, while the air holes 11a and associated circumferential air groove 11b in the outer surface 11c of the mandrel 11 desirably are located about fifteen millimetres axially inwardly from the nearer free edge 11d of the mandrel 11. Thus, when it becomes time to air mount a printing sleeve (not shown) on the outer surface 131b of the adapter sleeve 131, the protection ring 110 does not block the air flow reaching the outer surface 11c of the mandrel 11 from reaching the outer surface 131b of the flow-through adapter sleeve 131.

Moreover, when it becomes time to remove the sleeve 131 from the mandrel 11, the close fit between the outer surface 11c of the mandrel 11 and the inner circumferential surface 21 of the protection ring 110 intended for the trailing end of the sleeve 131 forces the compressed air escaping from the mandrel's air mounting holes 11a and filling the mandrel's air groove 11b to expand the innermost cylindrical surface 13 of the inner layer 12a against the expansion layer 12b of the sleeve 131 to allow the sleeve 131 to be slid off of the mandrel 11. Optionally, embodiments of the trailing end protection ring 110 intended for the trailing end of the sleeve (e.g., 131 shown in FIG. 6) need not be provided with a register notch 24.

The quick-connect protection ring 10, 110 for a printing sleeve 30, 31 or 131 is of simple and reliable use. The detachable connection between the protection ring 10, 110 and the sleeve 30, 31 or 131 being hence achieved by simply connecting the parts together without the need for mechanical fixing members or glue. Moreover, the quick-connect protection ring 10, 110 can be quickly and inexpensively replaced. The quick-connect protection ring 10, 110 also can be used with sleeves that employ a pin-and-slot or key-and-keyway locking system to secure the sleeve against rotation on the mandrel such as found in U.S. Pat. No. 6,360,662 to Busshoff.

While more than one presently preferred embodiments of sleeves with one or more protection rings for quick connection to the sleeve has been described using specific terms, each such description is for illustrative purposes only, and it is to be understood that changes and variations may be made without departing from the spirit or scope of the following claims.

What is claimed is:

1. A protection ring for a printing sleeve carrying the characters to be printed or for an adapter sleeve for supporting said printing sleeve, the innermost cylindrical surface of the sleeve to be mounted at a required orientation on a rotary mandrel having a register pin, one end of the sleeve defining a seat formed by an end flange and a circumferential shoulder that is connected to the end flange, the sleeve's end flange defining an inside cylindrical surface, the protection ring comprising:
an annular body defining an axis of rotation, an inner circumferential surface and an outer circumferential surface disposed concentrically with respect to the inner circumferential surface, the annular body further defining a first axial end and a second axial end disposed opposite the first axial end, the first axial end being configured to be disposed facing the seat of the sleeve;
a register notch defined in the second axial end of the annular body, the register notch being defined through the inner circumferential surface of the annular body and through the second axial end of the annular body and configured for receiving and engaging the mandrel's register pin;
a first member of a coupling, the first member being defined circumferentially about the outer circumferential surface of the annular body and configured with a shape complementary with the shape of a second member of the coupling defined in the seat of the sleeve so as to engage with said coupling's complementarily shaped second member and detachably lock the annular body in the seat of the sleeve against axial movement between the sleeve and the annular body; and
a first element of an orientation feature, said first element being defined in said outer circumferential surface of the annular body, said first element of the orientation feature being configured to engage with the orientation feature's complementarily shaped second element defined in the seat of the sleeve to ensure that the annular body becomes oriented on the sleeve such that the register notch lies in a suitable position for cooperation with the mandrel's register pin to ensure the required orientation of the sleeve on the rotary mandrel.

2. A protection ring as in claim 1, wherein the first member of the coupling includes a rib extending in the circumferential direction and configured to detachably engage and nest securely within a complementary groove defined circumferentially in the inside cylindrical surface of the seat of the sleeve.

3. A protection ring as in claim 2, wherein the rib forming the first member of the coupling is defined in part by a chamfered surface facing toward the first axial end of the annular body.

4. A protection ring as in claim 1, wherein said first element of an orientation feature being defined in said outer circumferential surface of the annular body diametrically opposite said register notch.

5. A protection ring as claimed in claim 1, wherein said first member of said coupling is at least one tooth projecting radially from the outer circumferential surface of the annular body, said tooth being configured to detachably engage and nest securely within a complementary slot provided in the inside cylindrical surface of the seat of the sleeve so that when the annular body is inserted into the seat provided in the end edge of the sleeve the inner circumferential surface of said annular body lies parallel to the innermost cylindrical surface of the sleeve and the second axial end face of said annular body lies coplanar with the outermost end edge of the sleeve.

6. A protection ring as claimed in claim 1, wherein said first member of said coupling is at least one groove extending radially into the outer circumferential surface of the annular body of the ring, said groove being configured to detachably engage and receive securely therein a complementary projection extending radially outwardly from the inside cylindrical surface of the flange of the seat of the sleeve such that the inner circumferential surface of the annular body of the ring lies parallel to the innermost cylindrical surface of the sleeve and the second axial end of said annular body lies coplanar with the outermost end edge of the sleeve.

7. A protection ring as claimed in claim 1, wherein the first element of the orientation feature includes a recess provided in the outer circumferential surface of the annular body, said recess being arranged to cooperate with a projection extending radially outwardly from the seat of the sleeve in a manner to prevent rotation of the ring with respect to the sleeve.

8. A protection ring as claimed in claim 1, wherein the first element of the orientation feature includes a projection extending radially outwardly from the outer circumferential surface of the annular body, said projection being arranged to cooperate with a recess provided in the seat of the sleeve in a manner to prevent rotation of the ring with respect to the sleeve.

9. A protection ring as in claim 1, wherein the first element of the orientation feature includes a cutout, the cutout being defined axially and radially through the outer circumferential surface of the annular body and configured to receive therein a complementarily shaped projection extending radially outwardly from the sect of the sleeve.

10. A protection ring as in claim 1, wherein the annular body being composed of rigid material having a hardness between about 40 Shore D and about 50 Shore D.

11. A protection ring as in claim 10, wherein the annular body being composed of rigid material having a hardness of about 45 Shore D.

12. A protection ring as claimed in claim 1, further comprising a removal seat that is defined in the second axial end of the annular body, said removal seat being configured to cooperate with a tool for detaching the protection ring from the sleeve.

13. A protection ring as claimed in claim 12, wherein said removal seat is defined by a dead-ended threaded hole.

14. A protection ring as claimed in claim 13, wherein said dead-ended hole has a threaded interior surface.

15. A protection ring as claimed in claim 12, wherein said removal seat is defined by a cutout through said first axial end and said inner circumferential surface of said annular body.

16. A protectively equipped sleeve for mounting in registry with a register pin on a rotatable cylinder for a printing machine, comprising:
an elongated cylindrical annular member rotatable about an axis of rotation and having a first end and a second end disposed axially apart from said first end, the first end of the sleeve defining a first seat including a circumferential shoulder and an inside cylindrical surface; and
a leading edge protection ring manually detachably connected to the seat in the first end of the elongated cylindrical annular member, the protection ring defining a register notch configured to receive and engage the register pin of the rotatable cylinder for the printing machine.

17. A protectively equipped sleeve as in claim 16, wherein the leading edge protection ring is configured as described in claim 1.

18. A protectively equipped sleeve as in claim 16, wherein the leading edge protection ring is configured as described in claim 2.

19. A protectively equipped sleeve as in claim 16, wherein the leading edge protection ring is configured as described in claim 5.

20. A protectively equipped sleeve as in claim 16, wherein the leading edge protection ring is configured as described in claim 6.

21. A protectively equipped sleeve as in claim 16, wherein the leading edge protection ring is configured as described in claim 7.

22. A protectively equipped sleeve as in claim 16, wherein the leading edge protection ring is configured as described in claim 8.

23. A protectively equipped sleeve as in claim 16, wherein the leading edge protection ring is configured as described in claim 9.

24. A protectively equipped sleeve as in claim 16, wherein the leading edge protection ring is configured as described in claim 10.

25. A protectively equipped sleeve as in claim 16, further comprising a trailing end protection ring, wherein the second end of the sleeve defining a second seat including a circumferential shoulder and an inside cylindrical surface, and wherein the trailing end protection ring being configured to be manually detachably connected to the second seat in the second end of the elongated cylindrical annular member, the trailing end protection ring defining an inner circumferential surface with a diameter the same as the diameter of the outer surface of the rotatable cylinder of the printing machine.
